(19) United States
(12) Patent Application Publication
(10) Pub. No.: US 2015/0291792 A1
(43) Pub. Date: Oct. 15, 2015

(54) COMPOSITES FOR USE IN INJECTION MOLDING PROCESSES

(71) Applicant: WKP PRODUCTS SA, Cadempino (CH)

(72) Inventor: Martin Maikisch, Satteins (AT)

(21) Appl. No.: 14/434,053

(22) PCT Filed: Oct. 7, 2013
(86) PCT No.: PCT/EP2013/070841

§ 371 Date: Apr. 7, 2015

(30) Foreign Application Priority Data
Oct. 8, 2012 (EP) 12187674.2

(51) Int. Cl. C08L 77/00

(52) U.S. Cl. CPC C08L 77/00; C08L 2207/04

(57) ABSTRACT

A composite comprising a polymer matrix component and a particulate filler component comprises 20-60 vol % of a thermoplastic polymer; 15-60 vol % of a first particulate filler component, wherein said first filler component is selected from the group consisting of powdered metals, metal oxides, covalent carbides, metalloid carbides, or mixtures of such powders; 5-30 vol % of a second particulate filler component, wherein said second filler component is an inorganic and/or mineral material in powder form; and 1-15 vol % of a coupling agent.

### CROSS-REFERENCE TO RELATED APPLICATIONS

This application is a U.S. National stage application of International Application No. PCT/JP2013/070841, flied Oct. 7, 2013, which claims priority to EP Patent Application No. 12187674.2 filed on Oct. 8, 2012, the contents of each of which are hereby incorporated herein by reference.

### BACKGROUND

1. Field of the Invention

The invention relates to composites comprising a polymer matrix and inorganic fillers.

2. Background Information

The plastic injection molding process has proven successful for cost-effective large-scale production of workpieces from plastics. It permits the production of parts to a high degree of accuracy and/or at a high rate of production. With the use of suitable injection dies, complicated geometries and even the production of internal threads and other undercut configurations are achievable. It is also feasible to produce components from different kinds of plastic in a single cycle.

The strength of workpieces produced by the injection molding process is a product of the plastic composition used. The plastics used must be thermoplastic, such that they can be introduced as a liquid melt under high pressure into the injection mold, where they solidify. Thermoplastic polymers that are used for injection molding are, for example, polypropylene PP, polymethylmethacrylate PMMA, polycarbonate PC, polystyrene PS, acrylonitrile-butadiene-styrene copolymer ABS, polyamide PA, polyoxymethylene POM, but also polyesters and polyvinyl chloride PVC.

The properties of plastics, for example the elasticity and mechanical strength, can be influenced by adding suitable functional fillers. Functional fillers such as glass fibers and wollastonite are used, inter alia, to improve the stiffness and flexural strength of polyesters, polyamides and polypropylenes. Such fillers are also used in thermoset resins such as epoxy resins, in order to thereby prevent stress cracks caused by shrinkage.

The use of plastic components may not be possible or desirable for certain applications, for various reasons. For example, the attainable mechanical strength of plastic parts may be inadequate for certain applications. In other cases, such as for high-priced consumer products, plastic components are not desirable in spite of comparable properties, because consumers traditionally associate plastics with low-quality products.

Metal materials have several advantages over plastics. For metal materials, various processes exist for cost-effective large-scale production, for example the die casting process. In this process, the liquid molten metal, for example aluminum, magnesium or zinc, is pressed under high pressure into a reusable casting mold, where it solidifies.

Because of the limited possibilities with respect to the casting mold in comparison with plastic injection molding, the production of complex-shaped workpieces by metal die casting is more elaborate, since, inter alia, a greater number of finishing steps may be required. Internal threads, for example, cannot be produced directly using the die casting process, but instead steel cores must be cast in, which are subsequently removed in a further cycle.

Epoxy resin prepolymers comprising metal powder as a filler (so-called “metal-filled epoxies”) are known from the prior art. The resulting compounds can be used as a curable material, for example for the repair of metal workpieces or for printing conductive tracks on printed circuit boards. Such epoxy materials, however, are thermosetting plastics, which are not suitable for the injection molding process.

Thermoplastic polymers with metal powder as a filler are also known from the prior art. However, these have only low mechanical strength. Fields of application are, for example, rapid prototyping processes in which aluminum powder-filled polyamide is laser-sintered in layers.

From EP 0185783 A1, a thermoplastic composition for the production of radio frequency-shielded housings for electronic devices is known. The composition comprises a thermoplastic polymer, coarse metal flakes, electrically conducting fibers, and electrically conducting carbon powder.

JP 63205362 likewise discloses a thermoplastic composition for producing radio frequency-shielding components, comprising a thermoplastic polymer, particles of a very low melting point metal alloy dispersed in the polymer, and glass fibers as a filler. Polymer/filler pellets and flakes of a (Pb—Sn—Sb) alloy are mixed together and extruded, the metal melting at the extrusion temperature and becoming finely distributed in the polymer as a result of the mixing. The soft metal alloy has low mechanical stability.

JP 2006096966 shows a thermoplastic composition for producing radio-frequency-shielding components. Bundles of fine steel fibers and glass fibers are drawn, impregnated with nylon 66 polymer, extruded, and pelletized to about 12 mm length. These fiber/nylon pellets and normal nylon pellets are extruded together in a weight ratio of about 1:1. The long fiber lengths make the composite unsuitable for relatively fine configurations.

Also known from the prior art are composites that comprise hard ferrite powder and thermosetting or thermoplastic polymers, for producing permanent magnets, which also have only comparatively low mechanical strength.

Accordingly, there is a need to combine the advantages of the die casting process and the injection molding process, and to make such production processes accessible to metals for which die casting is not possible.

### SUMMARY

The aim of the invention is to provide a material that does not have the aforementioned and other shortcomings. In particular, such a material should be processable using the injection molding process. After processing, the material should preferably have metal-like properties, for example in terms of strength, conductivity, specific gravity and appearance.

These and other aims are met by composites according to the invention; work pieces and semifinished products according to the invention that are made from such composites according to the invention; kits according to the invention for producing such composites; uses according to the invention of such composites; and processes according to the invention for producing such composites; as claimed in the independent claims. Further preferred embodiments are specified in the dependent claims.

### BRIEF DESCRIPTION OF THE DRAWINGS

Referring now to the attached drawings which form a part of this original disclosure.

FIG. 1 illustrates a breaking stress chart for M1, M2, M4 and M6-M8;

FIG. 2 illustrates a breaking stress chart for M1, M3 and M5;

FIG. 3 illustrates a notched bar impact chart for M1, M2, M4 and M6-M8; and

FIG. 4 illustrates a notched bar impact chart for M1, M3 and M5.

### DETAILED DESCRIPTION OF EMBODIMENTS

A composite according to the invention comprises a polymer matrix component and a particulate filler component comprises 20-60 vol %, preferably 20-50 vol % of a thermoplastic polymer; 15-60 vol % of a first particulate filler component, wherein said first filler component is selected from the group consisting of powdered metals, metal oxides, covalent carbides, metalloid carbides, or mixtures of such powders; 5-30 vol % of a second particulate filler component, wherein said second filler component is an inorganic and/or mineral material in powder form; and 1-15 vol % of a coupling agent.

The volume fraction Vᵢ is calculated from the proportion by weight mᵢ of each component i of a particular composition, divided by the specific gravity of the component ρᵢ, that is: Vᵢ=mᵢ/ρᵢ.

The relative volume fraction (vol %) Is defined as r_{V,i}=Vᵢ/Vₜₒₜₐₗ, the relative percentage by weight (wt %) as r_{m,i}=mᵢ/mₜₒₜₐₗ. The formula for converting a relative percentage by weight to a relative volume fraction is then:

$${r}_{v , i} = {V}_{i} / {Σ}_{n} {V}_{n} = ( {m}_{i} / {ρ}_{i} ) / {Σ}_{n} ( {m}_{n} / {ρ}_{n} ) = ( {r}_{m , i} ⋆ {m}_{total} / {ρ}_{i} ) / {Σ}_{n} ( {r}_{m , n} ⋆ {m}_{total} / {ρ}_{n} ) = ( {r}_{m , i} / {ρ}_{i} ) / {Σ}_{n} ( {r}_{m , n} / {ρ}_{n} ) \qquad ( I )$$

or conversely from a relative volume fraction to a relative percentage by weight:

$${r}_{m , i} = {m}_{i} / {Σ}_{n} {m}_{n} = ( {V}_{i} ⋆ {ρ}_{i} ) / {Σ}_{n} ( {V}_{n} ⋆ {ρ}_{n} ) = ( {r}_{V , i} ⋆ {V}_{total} ⋆ {ρ}_{i} ) / {Σ}_{n} ( {r}_{V , n} ⋆ {V}_{total} ⋆ {ρ}_{n} ) = ( {r}_{V , i} ⋆ {ρ}_{i} ) / {Σ}_{n} ( {r}_{V , n} ⋆ {ρ}_{n} ) \qquad ( II )$$

The term “metal,” in the context of this description, refers to both pure metals and alloys of metals. The term “polymer” refers to both pure polymers and copolymers and polymer blends.

Advantageously, the proportion of the thermoplastic polymer is 33-44 vol %, and/or the proportion of the first filler component is 29-51 vol %, and/or the proportion of the second filler component is 8-21 vol %, and/or the proportion of the coupling agent is 6-9 vol %.

In an advantageous embodiment of such a composite according to the invention, the first filler component contains a powdered metal selected from the group consisting of bronze, brass, copper, iron, steel, zinc, magnesium, aluminum, or mixtures of such powders.

In another advantageous embodiment of such a composite according to the invention, the first filler component contains a powdered metal selected from the group consisting of gold, silver, platinum, palladium, tungsten, and alloys containing such metals, or mixtures of such powders.

In a further advantageous embodiment of such a composite according to the invention, the first filler component contains a ferromagnetic metal oxide in powder form.

In a composite according to the invention, the second filler component is preferably selected from the group consisting of wollastonite, glass fibers, calcined silica, calcined kaolinite, or mixtures thereof.

The thermoplastic polymer of a composite according to the invention advantageously contains at least one polyamide and/or polyamide copolymer.

Advantageously, a composite according to the invention contains as a coupling agent a mixture of a silane having three alkoxy groups and an alkyl group with amino functionality, and a silane having three alkoxy groups and an alkyl group with epoxy functionality. Particularly advantageously, the coupling agent in such an embodiment variant is a mixture of 3-aminopropyltriethoxysilane and 3-(2,3-epoxypropoxy)-propyltrimethoxysilane.

In another embodiment of a composite according to the invention, the coupling agent contains maleic anhydride-grafted polyethylene or maleic anhydride-grafted polypropylene.

Advantageously, a composite according to the invention is pelletized. This allows easy use in conventional injection molding equipment.

Workpieces and semifinished products according to the invention are made from such composites according to the invention.

A kit according to the invention for producing a composite according to the invention comprises the individual components of the composite in separated form, and/or in mixed but not yet processed form. This means that individual components are present as unmixed powders, or two or more of the components are premixed, that is, are present as a powder mixture, or as a mixture of a powder and a liquid coupling agent. Such a kit may then, optionally after pre-mixing the components, be fed directly to a kneading apparatus, in which the composite according to the invention is then formed.

In a use according to the invention, a composite according to the invention is used for the production of workpieces using an injection molding process or a blow-molding process.

The examples given below serve to better illustrate the invention, but are not intended to limit the invention to the features disclosed herein.

Various embodiment variants of compositions of composites according to the invention will be described below with different proportions of the components. The examples were carried out in each case using five different metal powders having different particle morphologies (see Table 1).

TABLE 1

| | | Particle | | |
|---|---|---|---|---|
| Type No. | Kind | morphology | Particle size | Bulk density |
| A | Bronze | spherical | about 25 μm | about 5 g/cm³ |
| B | Bronze | spattered | about 35 μm | about 3 g/cm³ |
| C | Brass | spherical | about 65 μm | about 3 g/cm³ |
| D | Copper | leaf-like | about 45 μm | about 1 g/cm³ |
| E | Copper | spherical | about 50 μm | about 5 g/cm³ |

Spherical and “spattered” particle shapes arise during atomization of metal melts, the particle shape depending on the kind of metal and the atomization conditions. Leaf-like particles are formed during grinding in a ball mill.

Suitable metal powders are offered, for example, by Carl Schlenk AG, DE-91154 Roth, under the names Rogal Copper Powder GK, Cubrotec, Rogal Bronze Powder GS, Rogal Bronze Powder GK, Rogal Brass Powder GS.

### Example 1

In a first exemplary embodiment, the following compositions are used for five compound materials 1.A, 1.B, 1.C, 1.D, 1.E according to the invention: 10 wt % polyamide PA 12 as a polymer component, 80 wt % metal powder A, B, C, D or E as in Table 1 (the letter of the given material designates the metal powder used) as a first filler component, 8 wt % wollastonite having a fiber length of about 250 μm and a fiber diameter of about 15 μm as a second filler component, and 2% by weight of a coupling agent component consisting of 3-aminopropyltriethoxysilane and 3-(2,3-epoxypropoxy) propyl trimethoxysilane in a weight ratio of 1:1.

TABLE 1A

| | | | | Coupling |
|---|---|---|---|---|
| | Polymer | Metal | Wollastonite | Agent |
| Composition No. | [wt %] | [wt %] | [wt %] | [wt %] |
| 1.A, 1.B (Metal: bronze) | 10 | 80 | 8 | 2 |
| 1.C (Metal: brass) | 10 | 80 | 8 | 2 |
| 1.D, 1.E (metal: copper) | 10 | 80 | 8 | 2 |

Polyamide PA 12 is a thermoplastic polymer of 12-aminododecanoic acid monomers. It has been known for a long time and is available from various manufacturers, for example from Evonik Industries AG, DE 45128 Essen, Germany, under the type designation Vestamid® L1670.

Wollastonite is a naturally occurring calcium silicate mineral having fibrous to needle-like crystals that is used as a functional filler in thermoplastic polymers in order to improve the creep resistance, the stiffness and the bending strength of thermoplastic materials. Wollastonite is offered by different manufacturers, for example by Fibertec Inc., Bridgewater, Mass. 02324.

3-aminopropyltriethoxysilane (APTES, CAS no. 13822-56-5) is used for surface treatment of wollastonite as a filler for polyamides, in order to achieve a chemical bond between the wollastonite particles and the surrounding polymer matrix, and thereby increased strength. The product is available for example from Jingzhou Jianghan Fine Chemical Co. Ltd., Hubei, 434005, China, under the type designation JH-A110. The density is 0.945 g/cm³. Alternatively, other amino silanes such as 3-aminopropyltrimethoxysilane, N-(2-aminoethyl)-3-aminopropyltrimethoxysilane, N-(2-aminoethyl)-3-aminopropyltriethoxysilane, 3-ureidopropyltriethoxysilane, N-(2-aminoethyl)-3-aminopropylmethyldimethoxysilane and 3-aminopropyl-methyldiethoxysilane can be used as well.

3-(2,3-Epoxypropoxy)propyl-trimethoxysilane (GPTMS, 3-glycidoxypropyltrimethoxysilane, CAS no. 2530-83-8) is also used for surface treatment of wollastonite. The product is available, for example, from Jingzhou Jianghan Fine Chemical Co. Ltd., Hubei, 434005, China, under the type designation JH-O187. The density is 1.07 g/cm³.

The individual components of the compositions are mixed and pelletized in the usual manner. In order to do this, preferably, the wollastonite is mixed with the coupling agent component in a first step. The resulting granules can subsequently be processed in a conventional injection molding system.

The advantageous materials mentioned make it possible to manufacture components by injection molding, that is, with the associated advantageous possibilities regarding geometry, precision and unit costs. At the same time, the workpieces have metal-like properties, for example with respect to the specific weight, visual appearance, electrical conductivity and thermal conductivity. Even the surface feel of the material is similar to metals, since the workpieces feel cool to the touch.

The resulting work pieces achieve the mechanical properties of workpieces made of conventional polyamide materials, despite their low polymer content. The negative influence of the high filling ratio on the mechanical strength, such as is known in polymers from the prior art that have metal fillers, does not occur in the aforementioned advantageous compositions of compound materials according to the invention.

Without wishing to be confined to a specific principle of function, it is assumed that these advantageous mechanical properties of the materials according to the invention derive from the fact that the particles of the two different filler components—in the present case the metal powder and the wollastonite—become chemically cross-linked by the two coupling agents. The silane terminus of 3-aminopropyltriethoxysilane and 3-(2,3-epoxypropoxy)-propyltrimethoxysilane binds to the silicon-containing mineral structure of the wollastonite particles. The epoxy terminus of 3-(2,3-epoxypropoxy)propyltrimethoxysilane binds to the surface of the metal particles, while the amino terminus of 3-aminopropyltriethoxysilane serves to bind to the polyamide matrix.

The mechanical strength of the resulting particle composite results, on the one hand, from the internal strength of the wollastonite particles and metal particles, on the other hand from the mechanical interaction of the particles within the polymer matrix, and finally from the two different types of particles binding to one another. Spattered metal particles offer greater strength in comparison with spherical particles due to the more irregular shape, and also higher electrical conductivity due to the increased number of contact points between the metal particles. Due to the low volume fraction, the matrix of the polyamide plays a smaller role in the strength, which is made up for according to the invention, however, by the wollastonite particles and metal particles binding to each other owing to the coupling agent components.

Upon converting the proportions by weight of the individual components (see Table 1a) to volume fractions using a density of polyamide 12 of about 1.14 g/cm³, of wollastonite of about 2.8 g/cm³, of bronze of about 8.0 g/cm³, of brass of about 8.5 g/cm³, of copper of about 8.94 g/cm³, and the same density for the coupling agent mixture (the theoretical value would be 1.0075 g/cm³) as for the polyamide, which, given the low proportion by weight, has no relevant effect, then the following proportions in vol % are obtained for compositions 1.A through 1.E according to the above formula (I):

TABLE 2

| | | | | Coupling | |
|---|---|---|---|---|---|
| | Polymer | Metal | Wollastonite | Agent | Density: |
| Composition No. | [vol %] | [vol %] | [vol %] | [vol %] | [g/cm³] |
| 1.A, 1.B | 37.5 | 42.8 | 12.2 | 7.5 | 4.3 |
| (Metal: bronze) | | | | | |
| 1.C (Metal: brass) | 38.5 | 41.3 | 12.5 | 7.7 | 4.4 |
| 1.D, 1.E | 39.3 | 40.1 | 12.8 | 7.9 | 4.5 |
| (Metal: copper) | | | | | |

The density ρ_{comp.} of the composition is obtained from

$${ρ}_{comp .} = {m}_{comp .} / {V}_{comp .} = {Σ}_{n} {m}_{n} / {Σ}_{n} {V}_{n} = {Σ}_{n} {V}_{n} {ρ}_{n} / {Σ}_{n} {V}_{n} = {Σ}_{n} {r}_{V , n} {V}_{total} {ρ}_{n} / {Σ}_{n} {r}_{V , n} {V}_{total} = {Σ}_{n} {r}_{V , n} {ρ}_{n} / {Σ}_{n} {r}_{V , n} = {Σ}_{n} {r}_{V , n} {ρ}_{n} \qquad ( III )$$

Said materials therefore have a density of about 4.3-4.5 g/cm³, which corresponds to more than half of that of the base metal, and about four times that of the polymer material.

The specific weight of the metal as a first filler component and of the wollastonite as a second filler component play no role in the mechanical properties of the materials. Different variants according to the invention can therefore be most easily compared with each other by converting the specific weight ρᵢ of a modified component to a comparison component. For example, for compositions 1.C to 1.E, the proportions by weight rₘₑₜₐₗ of brass or copper can be converted to the theoretical proportion by weight r_{bronze} of bronze, at unchanged volume Vₘₑₜₐₗ of the metal component. In other words, the proportion by weight is calculated as if one had replaced the specific metal component of the composition with bronze.

TABLE 3

| | | | | Coupling |
|---|---|---|---|---|
| | Polymer | Metal * | Wollastonite | Agent |
| Composition No. | [wt %] | [wt %] | [wt %] | [wt %] |
| 1.A, 1.B (Metal: bronze) | 10 | 80 | 8 | 2 |
| 1.C (Metal: brass) | 10.5 | 79 | 8.4 | 2.1 |
| 1.D, 1.E (Metal: copper) | 10.9 | 78.2 | 8.7 | 2.2 |

* Converted to the theoretical proportion by weight of bronze (8.0 g/cm³), at unchanged volume fraction

In Example 1.C, the theoretical proportion by weight of the metal (brass) of r_{m,brass}=80 wt % converted to brass therefore is as follows: r*_{m,bass}=r_{m,bass}(ρ_{bronze}/ρ_{brass})/(r_{m,polym.}+r_{m,brass}(ρ_{bronze}/ρ_{brass})+r_{m,woll.}+r_{m,coup.})=0.79=79 wt %. The proportions by weight of the other components change as well, for example r*_{m,polym.}=r_{m,polym}/(r_{m,polym.}+r_{m,brass}(ρ_{bronze}/ρ_{brass})+r_{m,woll.}+r_{m,coup.})=10.5 wt %.

It should be emphasized that this theoretical proportion by weight converted to bronze is intended to serve primarily for comparison of compositions having different metals, without in each case having to calculate the relative volume fractions, or having greatly different specific gravities complicate the comparison.

Other polyamides such as PA 6 or PA 66 can be used instead of polyamide PA 12 as the polymer component. Polyphthalamide polymers PPA and other high-performance polymers can be used as well, such embodiment variants offering additional advantages, of course, due to the properties of the polymer component.

The polymer components used can also be other thermoplastic polymers, such as for example polypropylene, polymethylmethacrylate, polycarbonate, polystyrene, acrylonitrile-butadiene-styrene copolymer, polyamide, polyoxymethylene, polyester, polyvinyl chloride, and thermoplastic polyurethanes, in which case appropriate adjustments to the coupling agents may be necessary.

### Example 2

In a further exemplary embodiment, the proportions by weight of the components Were modified. The compositions of composites 2.a to 2.e according to the invention are Composed as follows: 8 wt % polyamide pa 12 as the polymer component, 85 wt % metal powder A, B, C, D, or E as in Table 1 as the first filler component, 5 wt % wollastonite having a fiber length of about 250 μm and a fiber diameter of about 15 μm as the second filler component, and 2% by weight of a coupling agent component consisting of 3-aminopropyltriethoxysilane and 3-(2,3-epoxypropoxyl)propyl trimethoxysilane in a weight ratio of 1:1. Converted to the volume fraction, this results in the compositions listed in Table 4:

TABLE 4

| | | | | Coupling | |
|---|---|---|---|---|---|
| | Polymer | Metal | Wollastonite | Agent | Density |
| Composition No. | [vol %] | [vol %] | [vol %] | [vol %] | [g/cm³] |
| 2.A, 2.B (Bronze) | 33.1 | 50.2 | 8.4 | 8.3 | 4.7 |
| 2.C (Brass) | 34.1 | 48.6 | 8.7 | 8.5 | 4.9 |
| 2.D, 2.E (Copper) | 35 | 47.4 | 8.9 | 8.7 | 5.0 |

This corresponds to a further increase in the specific gravity by about 10% in comparison with compositions 1.A to 1.E. Upon conversion to the density of bronze as a comparison, the values in Table 5 are obtained.

TABLE 5

| | | | | Coupling |
|---|---|---|---|---|
| | Polymer | Metal * | Wollastonite | Agent |
| Composition No. | [wt %] | [wt %] | [wt %] | [wt %] |
| 2.A, 2.B (Bronze) | 8 | 85 | 5 | 2 |
| 2.C (Brass) | 8.4 | 84.2 | 5.3 | 2.1 |
| 2.D, 2.E (Copper) | 8.8 | 83.5 | 5.5 | 2.2 |

* Converted to the theoretical proportion by weight of bronze (8.0 g/cm³), at unchanged volume fraction

### Example 3

In a yet further exemplary embodiment, the compositions of composites 3.A to 3.E according to the invention each comprise 13 wt % polyamide PA 12 as the polymer component, 70 wt % metal powder A, B, C, D, or E as in Table 1 as the first filler component, 15 wt % wollastonite having a fiber length of about 250 μm and a fiber diameter of about 15 μm as the second filler component and 2 wt % of a coupling agent component consisting of 3-aminopropyltriethoxysilane and 3-(2,3-epoxypropoxy)-propyltrimethoxysilane in a weight ratio of 1:1. Table 6 below contains the compositions converted to the volume fraction:

TABLE 6

| | | | | Coupling | |
|---|---|---|---|---|---|
| | Polymer | Metal | Wollastonite | Agent | Density |
| Composition No. | [vol %] | [vol %] | [vol %] | [vol %] | [g/cm³] |
| 3.A, 3.B (Bronze) | 41.8 | 32.1 | 19.6 | 6.4 | 3.7 |
| 3.C (Brass) | 42.6 | 30.8 | 20 | 6.6 | 3.7 |
| 3.D, 3.E (Copper) | 43.3 | 29.7 | 20.3 | 6.7 | 3.8 |

Commensurate with the lower metal content, the specific gravity of the material according to the invention decreases as well. Upon conversion to the density of bronze as a comparison, the values in Table 7 are obtained.

TABLE 7

| | | | | Coupling |
|---|---|---|---|---|
| | Polymer | Metal | Wollastonite | Agent |
| Composition No. | [wt %] | [wt %] | [wt %] | [wt %] |
| 3.A, 3.B (Bronze) | 13 | 70 | 15 | 2 |
| 3.C (Brass) | 13.6 | 68.7 | 15.6 | 2.1 |
| 3.D, 3.E (Copper) | 14 | 67.6 | 16.2 | 2.2 |

* Converted to the theoretical proportion by weight of bronze (8.0 g/cm³), at unchanged volume fraction

Instead of wollastonite as the second filler component, it is also possible to use glass fibers or calcined diatomaceous earth, or similar inorganic mineral components, in composites according to the invention. Similarly, wollastonite having other fiber parameters, or mixtures of different second filler components can be used as well.

### Examples 4, 5, 6

In another series of tests, maleic anhydride-grafted polyethylene (PEgMAH) is used as a coupling agent. These show slightly less good properties than the similar compositions of Examples 1, 2 and 3, since the bond is less specific.

The compositions of the thus obtained composites 4.A to 4.E according to the invention are: 10 wt % polyamide PA 12 as the polymer component, 80 wt % metal powders A, B, C, D or E as in Table 1 as the first filler component, 9 wt % wollastonite having a fiber length of about 250 μm and a fiber diameter of about 15 μm as a second filler component, and 1 wt % maleic anhydride-grafted polyethylene as a coupling agent component.

Composites 5.A to 5.E according to the invention, in turn, have the following compositions: 9 wt % polyamide PA 12, 85 wt % metal powder A, B, C, D, or E as in Table 1, 5 wt % wollastonite having a fiber length of about 250 μm and a fiber diameter of about 15 μm, and 1 wt % maleic anhydride-grafted polyethylene as a coupling agent component.

The compositions of composites 6.A to 6.E according to the invention are: 14 wt % polyamide PA 12, 70 wt % metal powder A, B, C, D, or E as in Table 1, 15 wt % wollastonite having a fiber length of about 250 μm and a fiber diameter of about 15 μm, and 1 wt % maleic anhydride-grafted polyethylene as a coupling agent component.

As an alternative to maleic anhydride-grafted polyethylene, it is also possible to use maleic anhydride-grafted polypropylene as a coupling agent component.

Composites according to the invention can also be used in multi-component injection molding. For example, work pieces which consist partly of novel composites and partly of conventional thermoplastic materials can be produced in a single cycle. It is possible, for example, to produce in an injection molding die a main body of a plug from composite 1.A, and then immediately thereafter mold on a sealing element of a thermoplastic elastomer. Similarly, components can be produced in a single cycle, in which two electrically conductive domains made of one material according to the invention are separated in an insulating manner by a polymer domain injection molded therebetween.

Composites according to the invention can also be used in other manufacturing processes that were previously likewise reserved to thermoplastic polymers, for example, various blow molding processes, such as for example extrusion blow molding and injection blow molding.

Instead of copper or copper-based alloys, it is also possible, like in the aforementioned examples, to use other metal or also mineral compounds as a first filler component. It is possible, for example, to use powders of steel or stainless steel (density about 7.4-8.0 g/cm³), zinc (about 7.1 g/cm³) or titanium (about 4.5 g/cm³). Various metal powders can also be used in the form of a powder mixture, in order to combine various properties of the metals.

The use of ferromagnetic compounds as first fillers, such as for example iron, cobalt or nickel, or the ferromagnetic oxides thereof, such as for example magnetite and hematite or ferrite, permit the production of permanent magnets with increased mechanical strength. These can be produced more cost-effectively than sintered or cast magnets, and have increased mechanical strength over conventional magnets having a polymer matrix.

Composites according to the invention can also be implemented with light metals or light metal alloys such as aluminum (about 2.7 g/cm³) or magnesium (about 1.7 g/cm³) instead of comparatively heavy metals. The specific gravity in this case is similar to the density of the polymer component and of the wollastonite. A composite similar to exemplary embodiment 1 having 80 wt % aluminum or magnesium as a first filler component produces an injection-moldable material according to the invention having a density of 2.3 g/cm³ or 1.7 g/cm³. Such materials in combination with the injection molding process provide an economical alternative to aluminum die casting, combined with the additional advantages of the injection molding process.

Heavier metals can be used as well for composites according to the invention, such as for example silver (about 10.5 g/cm³), palladium (about 12.2 g/cm³), gold (about 19.3 g/cm³), tungsten (about 19.6 g/cm³), or platinum (about 21.4 g/cm³). Such compositions are suitable, for example, for specific applications, for example in the area of jewelry and watches, especially for parts of watch cases, or for military applications.

For example, with a composition similar to Example 1 with 80 wt % gold, it is possible to implement a composite according to the invention having a density of about 5.7 g/cm³ that is visually very similar to pure metal gold, but is superior thereto in terms of workability, weight and material costs.

Similar to metals and metal alloys, it is also possible to use metal oxides as the first filler component or part of the first filler component, such as for example the aforementioned magnetite, or covalent carbides and metalloid carbides such as for example silicon carbide and tungsten carbide.

The injection-moldable composites according to the invention can be used also with other injection-moldable materials in a multi-component injection molding process, in order to, for example, produce only an outer layer, and/or an inner core of a workpiece from the composite.

### Further Examples

In order to investigate the mechanical strength, various compositions were prepared with copper as the metal component. In some compositions, the metal and wollastonite components were not coated with a coupling agent, in order to obtain reference values.

Various mixtures were prepared as in Table 8 below. The polymer used was polyamide PA6 (PA Technyl 206f, density 1.14 g/cm³, manufacturer: Rhodia Engineering Plastics, FR-69192 Saint-Fons, France).

In some mixtures, a second polymer component was added, namely maleic anhydride-modified homo polypropylene (Bondyram 1001, density 0.9 g/cm³, manufacturer: Polyram, Ram-On Industries LP, ISL-19205 Ram-On, Israel).

The copper was coated in the form of spherical copper powder (Rogal Copper GK 0/80) in a fluidized bed coating process using a 50:50 wt % mixture of silane JH-O187 and silane JH-A110. The coated copper powder was stored for three weeks, which resulted in the formation of lumps. The copper was subsequently re-pulverized with the aid of a ball mill. The amount of dust that developed was small, indicating only minor abrasion of the silane.

The copper powder may also advantageously be coated first with JH-O187 and then with JH-A110.

Wollastonite (Wollastonite Submicro, density 2.8 g/cm³, manufacturer: Kärntner Montanindustrie Ges.m.b.H., AT-9400 Wolfsberg, Austria) was used as inorganic/mineral filler component, coated with silane JH-O187 and silane JH-A110 in a fluidized bed coating process.

In a first variant, a 50:50 wt % mixture of the two components silane JH-O187 and silane JH-A110 (average density 1.0075 g/cm³) was used. In a second variant, the addition took place staggered, first the silane JH-A110 and then the silane JH-O187.

TABLE 8

| | | | Copper | |
|---|---|---|---|---|
| | Polyamide | Bondyram | batch | Wollastonite |
| Composition No. | [wt %] | [wt %] | [wt %] | batch [wt %] |
| M1 (reference mixture) | 20 | — | 65 (A) | 15 (A) |
| M2 (reference mixture) | 15 | — | 70 (A) | 15 (A) |
| M3 (reference mixture) | 15 | 5 | 65 (A) | 15 (A) |
| M4 | 20 | — | 65 (B) | 15 (D) |
| M5 | 15 | 5 | 65 (B) | 15 (D) |
| M6 | 20 | — | 65 (C) | 15 (E) |
| M7 | 20 | — | 65 (C) | 15 (F) |
| M8 | 20 | — | 65 (C) | 15 (G) |

The coating conditions of the different batches of copper and wollastonite used are designated (A)-(G). (A): no coating; (B): coated with 2.5 wt % silanes, at 60° C. to 30° C.; (C) coated with 0.5 wt % silanes, at 30° C.; (D): 1:1 mixture of two batches, coated with 5 wt % silanes, at 30° C. and 90° C., respectively; (E) coated with 5 wt % silanes, staggered, first JH-A110 then JH-O187, at 30° C.; (F) coated with 5 wt % silanes, staggered, first JH-A110 then JH-O187, at 60° C.; (G) coated with 5 wt % silanes, staggered, first JH-A110 then JH-O187, at 90° C.

A composition comprising 65 wt % copper batch (B) thus corresponds to 65 wt %*100/(100+2.5)=63.4 wt % copper and 65 wt %*2.5/(100+2.5)=1.6 wt % silanes as coupling agent. The calculations for the other batches are similar. This results in the following proportions by weight, shown in Table 9:

TABLE 9

| | Polymer | Copper | Wollastonite | Coupling |
|---|---|---|---|---|
| Composition No. | [wt %] | [wt %] | [wt %] | Agent [wt %] |
| M1 (reference mixture) | 20 | 65 | 15 | — |
| M2 (reference mixture) | 15 | 70 | 15 | — |
| M3 (reference mixture) | 20* | 65 | 15 | — |
| M4 | 20 | 63.4 | 14.3 | 1.6 + 0.7 = 2.3 |
| M5 | 20* | 63.4 | 14.3 | 1.6 + 0.7 = 2.3 |
| M6 | 20 | 64.7 | 14.3 | 0.3 + 0.7 = 1 |
| M7 | 20 | 64.7 | 14.3 | 0.3 + 0.7 = 1 |
| M8 | 20 | 64.7 | 14.3 | 0.3 + 0.7 = 1 |

*averaged density 1.08 g/cm3
According to formula (I), this results in the following volume fractions (Table 10):

TABLE 10

| | | | | Coupling |
|---|---|---|---|---|
| | Polymer | Copper | Wollastonite | Agent |
| Composition No. | [vol %] | [vol %] | [vol %] | [vol %] |
| M1 (reference mixture) | 58.1 | 24.1 | 17.8 | — |
| M2 (reference mixture) | 50.0 | 29.7 | 20.3 | — |
| M3 (reference mixture) | 59.5 | 23.3 | 17.2 | — |
| M4 | 54.8 | 22.1 | 16.0 | 7.1 |
| M5 | 56.1 | 21.5 | 15.5 | 6.9 |
| M6 | 56.8 | 23.5 | 16.5 | 3.2 |
| M7 | 56.8 | 23.5 | 16.5 | 3.2 |
| M8 | 56.8 | 23.5 | 16.5 | 3.2 |

Compounding of the composition was performed using a co-rotating twin screw extruder (standard screw with medium shear rate). The throughput was 15 kg/h, the temperature 230° C. over the entire length. The polymer, or the two polymer components and the wollastonite, respectively, were metered into the extruder together, at the beginning of the screw. The copper was added by side feeding. In a subsequent pressure-free zone a vacuum was applied to remove gases from the material. The resulting mixed composition was then pelletized.

### Tensile Tests

Using an injection-molded flat tensile specimen and a rate of elongation of 1 mm/min, experimental tensile tests were performed, and the tensile force at which the specimen breaks (“breaking stress”) was determined. To prepare the flat tensile specimens, the compounded pellets were dried for at least 3 hours at 80° C. and tensile test bars were then injection-molded therefrom. In order to achieve values as close as possible to field conditions, these tensile test bars were stored for 2 days in the air and then tested.

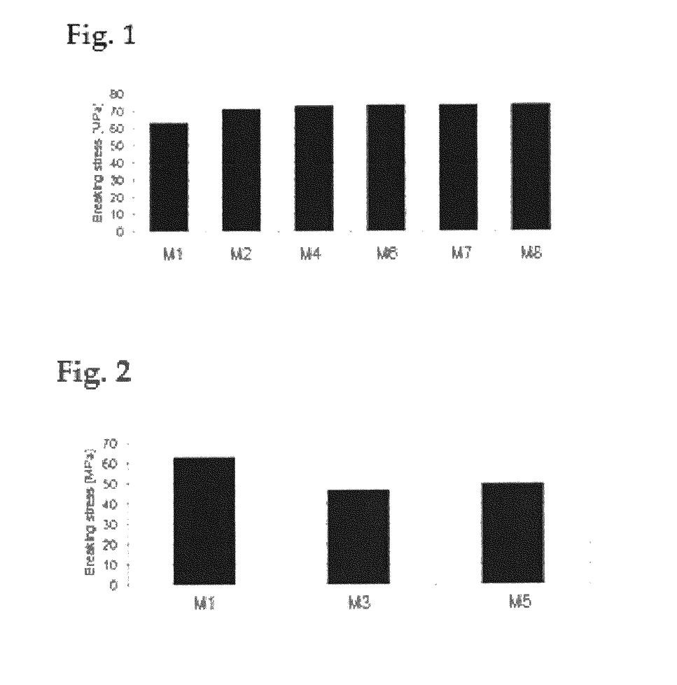

The results are shown in FIGS. 1 and 2. The measurement accuracy is about 1 MPa.

FIG. 1 shows the results of the compositions using polyamide 6 as the polymer component. The reference mixture M1 shows a breaking stress of 62.9±1.9 MPa (=N/mm2). When copper and wollastonite are coated using the coupling agent mixture (compositions M4, M6, M7, M8), the breaking stress increases by 17.6% to 74 MPa, irrespective of the coating parameters.

When two polymer components (compositions M3, M5) are used, that is to say, 25% (relatively) of the polyamide 6 are replaced with Bondyram, the breaking stress decreases, as shown in FIG. 2. In reference mixture M3, the breaking stress is still 46.5±0.5 MPa. As a result of the surface modification of copper and wollastonite (composition M5), the breaking stress increases by 7.5% to just under 50 MPa. The lower breaking stress values for M3 and M5 are probably due to a low compatibility of the two polymer components (polyamide is more polar than Bondyram (a modified polypropylene).

The modulus of elasticity was determined from the stress-strain diagram of the tensile tests, in the range of 0.1-0.3% elongation. The modulus of elasticity of compositions M1, M4, M6, M8 is in each case about 7.7 GPa. The modulus of elasticity of composition M2 is 9.8 GPa, which can presumably be attributed to the increased proportion of wollastonite and copper in comparison with polyamide. The modulus of elasticity of compositions M3 and M5 is 6.6 GPa. The scattering of the measured values is 0.1-0.4 GPa.

### V-Notch Tests

Charpy V-notch tests (DIN EN ISO 179-1) were performed in order to determine the impact toughness of the compositions. The behavior of an elongated cuboid, which is notched on one side, is examined at high deformation velocity (impact stress). The test consists of a pendulum hammer striking the unnotched back of the specimen with a certain kinetic energy and breaking it in the process. At the moment of impact on the specimen, part of the kinetic energy of the hammer is absorbed by deformation processes in the specimen. The pendulum hammer then swings less high on the other side according to the energy that is absorbed during breaking of the specimen.

The pendulum had a kinetic energy of 11 J. The specimens were prepared from the parallel zone of the tensile bars. The dimension of the V-notch test specimens was 4×10×80 mm. The notch was cut into the narrow side (notch A, 2 mm), the cross-section tested thus was 4×8 mm.

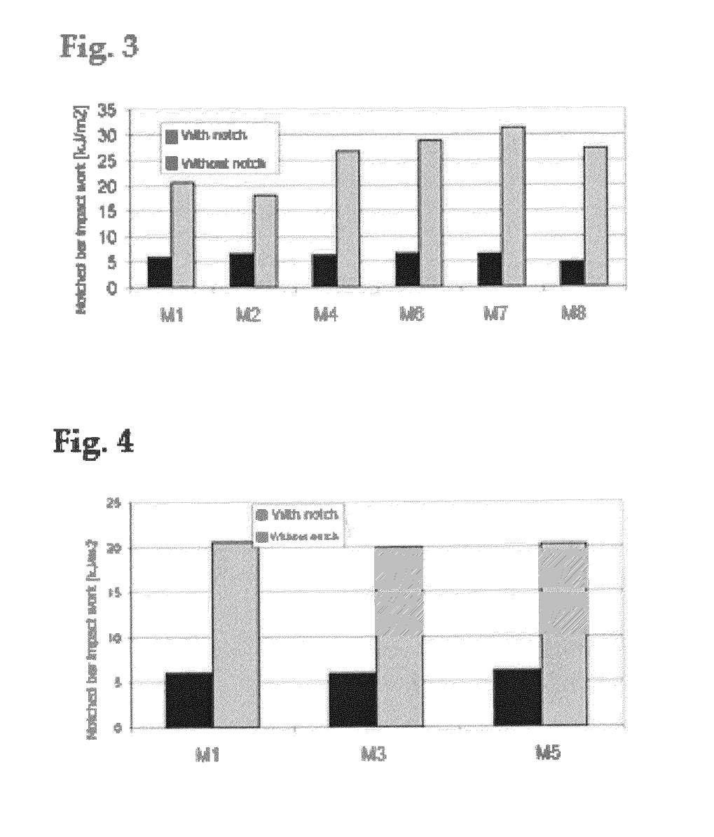

The tests were carried out in each case with notched and unnotched specimens. The results are shown in FIGS. 3 and 4.

As with the breaking stress, the surface treatment of the metal and wollastonite component made it possible to achieve an improvement in the measured values. The effect is particularly strong on the unnotched specimens. The results are shown in FIG. 3.

The notched specimens all have a notched bar impact work between 6 and 6.5 kJ/m2. As a result of the surface modification, it was possible to achieve an increase in the notched bar impact work in the unnotched specimens from 20.5±0.2 kJ/m2 (reference mixture M1) to 31.4±1.9 kJ/m2 (mixture M7). This is an improvement of over 50%.

An increase in the amount of copper (reference mixture M2) at the expense of the proportion of PA results in a lower absorption of the impact energy. This is probably because the mixture contains less polymer and therefore less malleable material that can absorb the impact energy. Copper, due to the much higher strength, absorbs less energy than polymer.

When the two silane components were added staggered during the fluidized bed coating of the wollastonite (mixtures M6, M7, M8), the resulting material was a little more impact resistant as compared to when the two silane components were added in mixed form (M4 mixture).

A combination of polyamide and Bondyran (compositions M3 (reference), M5) showed no increase in notched bar impact work compared to the reference specimen M1, irrespective of any surface treatment. The corresponding results are shown in FIG. 4.

The results suggest that the process temperature during the fluidized bed coating has no influence on the final product, since the silane components were given enough time during storage to chemically react (which in the case of copper led to the formation of lumps and necessitated a remilling).

Bondyram had no positive effect on the strength, but in the case of the breaking stress had a negative impact, which is probably due to demixing processes of the two polymer components during extrusion. Surprisingly, the silane coupling agent component also had no positive effect (the impact strength in M3 and M5 is essentially the same), or less of an effect than with pure polyamide (breaking stress).

Compositions M6-M8 show the best results, both in terms of breaking stress and impact toughness.

The present invention is not limited in scope to the specific embodiments described herein. Rather, in addition to the examples disclosed herein, various further modifications of the present invention, which likewise fall within the scope of the claims, will occur to those of ordinary skill in the art.

1. A composite comprising a polymer matrix component and a particulate filler component, characterized in that the composite comprises:
20-60 vol % of a thermoplastic polymer;
15-60 vol % of a first particulate filler component, wherein said first filler component is selected from the group consisting of powdered metals, metal alloys, metal oxides, covalent carbides, metalloid carbides, or mixtures of such powders;
5-30 vol % of a second particulate filler component, wherein said second filler component is an inorganic and/or mineral material in powder form; and
1-15 vol % of a coupling agent.

2. The composite according to claim 1, characterized in that the proportion of the thermoplastic polymer is 20-50 vol %, preferably 33-44 vol %, and/or the proportion of the first filler component is 29-51 vol %, and/or the proportion of the second filler component is 8-21 vol %, and/or the proportion of the coupling agent is 6-9 vol %.

3. The composite according to claim 1 characterized in that the first filler component contains a powdered metal selected from the group consisting of bronze, brass, copper, iron, steel, zinc, magnesium, aluminum, or mixtures of such powders.

4. The composite according to claim 1, characterized in that the first filler component contains a powdered metal selected from the group consisting of gold, silver, platinum, palladium, tungsten, and alloys containing such metals, or mixtures of such powders.

5. The composite according to claim 1, characterized in that the first filler component contains a ferromagnetic metal oxide in powder form.

6. The composite according to claim 5, characterized in that the second filler component is selected from the group consisting of wollastonite, glass fibers, calcined silica, calcined kaolinite, or mixtures thereof.

7. The composite according to claim 6, characterized in that the thermoplastic polymer contains at least one polyamide and/or polyamide copolymer.

8. The composite according to claim 7, characterized in that the coupling agent contains a mixture of a silane having three alkoxy groups and an alkyl group with amino functionality, and a silane having three alkoxy groups and an alkyl group with epoxy functionality.

9. The composite according to claim 8, characterized in that the coupling agent contains a mixture of 3-aminopropyltriethoxysilane and 3-(2,3-epoxypropoxy)-propyltrimethoxysilane.

10. The composite according to claim 7, characterized in that the coupling agent contains maleic anhydride-grafted polyethylene or maleic anhydride-grafted polypropylene.

11. The composite according to any one of the preceding claims, characterized in that the composite is palletized.

12. Workpieces and semifinished products produced from a composite according to claim 11.

13. A kit for producing a composite according to claim 11, containing the individual components of the composite in separated form, and/or in mixed but not yet processed form.

14. Use of a composite according to claim 11 for producing workpieces using an injection molding process or a blow molding process.
